(19) United States
(12) Patent Application Publication
(10) Pub. No.: US 2012/0099776 A1
(43) Pub. Date: Apr. 26, 2012

(54) MEDICAL IMAGE PROCESSING APPARATUS

(76) Inventors: Tatsuo MAEDA, Nasushiobara-shi (JP); Tatsuya Kimoto, Otawara-shi (JP)

(21) Appl. No.: 13/339,930

(22) Filed: Dec. 29, 2011

Related U.S. Application Data
(63) Continuation of application No. PCT/JP11/73235, filed on Oct. 7, 2011.

(30) Foreign Application Priority Data
Oct. 7, 2010 (JP) 2010-227886

(51) Int. Cl. G06K 9/62

(52) U.S. Cl. 382/131

(57) ABSTRACT

It is a subject to reduce the number of processing steps and shorten the processing time when specifying a branch position in a tubular structure, mainly the bronchus or blood vessel. A apparatus includes a storage unit which stores volume data concerning a 3D region of a subject as a target. A tomogram generation unit generates the data of slice images respectively corresponding to slices almost perpendicular to a predetermined reference axis from volume data files. A region extraction unit extracts regions associated with a target site from the plurality of slice images by using threshold processing. A position specifying unit specifies a position on the reference axis, wherein the number of extracted regions changes at the position.

### CROSS REFERENCE TO RELATED APPLICATIONS

This application is a Continuation Application of PCT Application No. PCT/JP2011/073235, filed Oct. 7, 2011 and based upon and claiming the benefit of priority from prior Japanese Patent Application No. 2010-227886, filed Oct. 7, 2010, the entire contents of all of which are incorporated herein by reference.

### FIELD

Embodiments described herein relate generally to a medical image processing apparatus.

### BACKGROUND

With a dramatic increase in the number of rows of X-ray detectors in an X-ray computed tomography apparatus, it has begun to be possible to acquire the projection data of the overall lung fields at once. Accordingly, various attempts have been made to apply this technique to the automatic provision of diagnosis support information by using volume data lightly influenced by movement artifacts due to respiration or pulsation. For example, there is available a function of obtaining volume data associated with the overall lung fields, extracting a branch of the bronchus, and displaying a tomogram of that position.

In this processing, a bronchus region is extracted in three dimensions, the center line of the tubular structure is identified, and a branch is specified from the center line structure.

Bronchus region extraction processing, center line identity processing, and branch specifying processing are all processing in three dimensions, each of which requires a very large number of processing steps and a very long processing time.

### Citation List

### Patent Literature

Patent Literature 1: Jpn. Pat. Appln. KOKAI Publication No. 2010-136765

### BRIEF DESCRIPTION OF THE DRAWINGS

FIG. 1 is a view showing the overall arrangement of an X-ray computed tomography apparatus including a medical image processing apparatus according to an embodiment.

FIG. 2 is a flowchart showing a procedure for bronchus branch position specifying processing in this embodiment.

FIG. 3 is a view showing an example of a search range in step S11 in FIG. 1.

FIG. 4 is a view showing a series of slices of slice images generated in step S12 in FIG. 1.

FIG. 5 is a view showing binary image examples generated in step S13 in FIG. 1.

FIG. 6 is a view showing changes in the number of bronchus regions determined in step S17 in FIG. 1.

FIG. 7 is a flowchart showing another procedure for bronchus branch position specifying processing in this embodiment.

### DETAILED DESCRIPTION

In general, according to one embodiment, a medical image processing apparatus includes:
a storage unit configured to store volume data concerning a three-dimensional region of a subject;
a tomogram generation unit configured to generate data of a plurality of slice images respectively corresponding to a plurality of slices substantially perpendicular to a predetermined reference axis from the volume data files;
a region extraction unit configured to extract a plurality of regions associated with a target site from the plurality of slice images by using threshold processing; and
a position specifying unit configured to specify a position on the reference axis, wherein the number of extracted regions changes at the position.

A medical image processing apparatus according to an embodiment will be described below with reference to the accompanying drawings.

Note that the medical image processing apparatus suitable for a medical image generator which can generate volume data associated with a three-dimensional region of a subject, e.g., an X-ray computed tomography apparatus, magnetic resonance imaging apparatus (MRI), ultrasonic diagnostic apparatus, or X-ray diagnostic apparatus. The medical image processing apparatus according to this embodiment is incorporated in such a medical image generator or functions standalone. The medical image processing apparatus functioning standalone according to this embodiment is connected to an electrical communication line such as a LAN and receives volume data from a medical image generator or an in-hospital or out-of-hospital picture archiving and communication system (PACS) via the electrical communication line. Assume that in the following description, the medical image processing apparatus according to this embodiment is incorporated in an X-ray computed tomography apparatus.

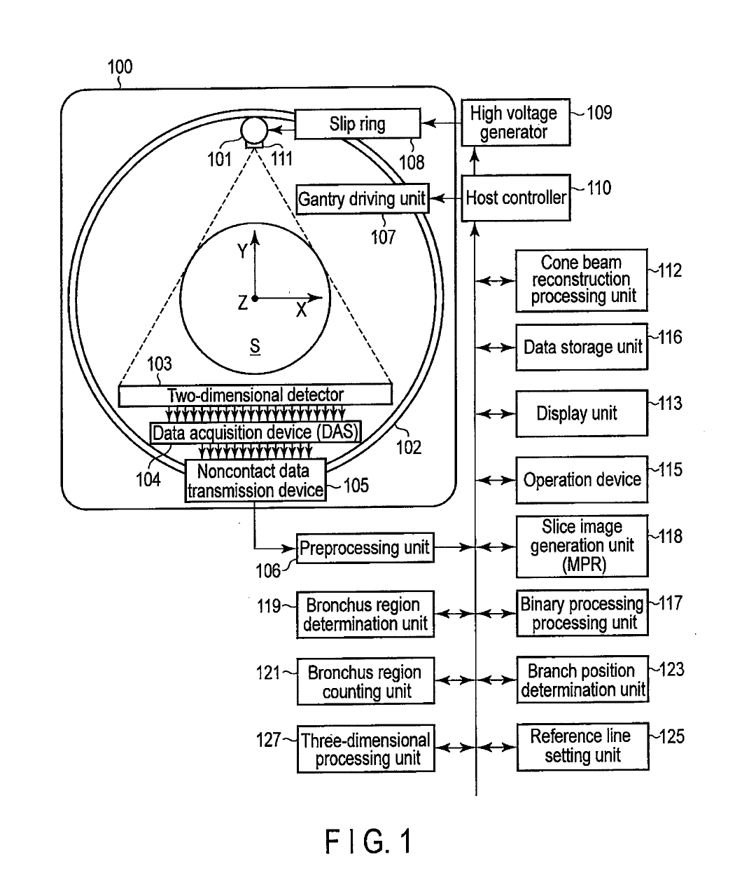

FIG. 1 is a block diagram showing the arrangement of the X-ray computed tomography apparatus including the medical image processing apparatus according to this embodiment. A gantry unit 100 includes a rotating frame 102 which is rotatably supported. In the following description, assume that the rotation center axis of the rotating frame 102 is the Z-axis, the horizontal direction is. the X-axis, and the vertical direction is the Y-axis. The body axis of a subject inserted in an imaging area S inside the rotating frame 102 almost coincides with the Z-axis when imaging is to be performed.

A gantry driving unit 107 generates a driving signal for rotating/driving the rotating frame 102 under the control of a host controller 110. A cone beam X-ray tube 101 and a two-dimensional detector (also called an area detector) 103 are mounted on the rotating frame 102 so as to face each other through the imaging area S centered on the Z-axis. A high voltage generator 109 supplies a tube current to the X-ray tube 101 and also applies a high voltage to it under the control of the host controller 110. With this operation, the subject is irradiated with the X-rays emitted from a focus F of the X-ray tube 101 and shaped into a quadrangular pyramidal shape by an X-ray stop 111. The two-dimensional detector 103 includes a plurality of X-ray detection elements each forming a channel. A plurality of X-ray detection elements are arrayed in an almost arc shape centered on the X-ray focus F around the X- and Z-axes.

A data acquisition device 104 generally called a DAS (Data Acquisition System) is connected to the two-dimensional detector 103. The data acquisition device 104 is provided with, for each channel, an I-V converter for converting a current signal from each channel of the two-dimensional detector 103 into a voltage, an integrator which periodically integrates the voltage signal in synchronism with the irradiation period of X-rays, an amplifier which amplifies an output signal from the integrator, and an analog/digital converter which converts an output signal from the preamplifier into a digital signal. A preprocessing unit 106 is connected to the output of the data acquisition device 104 via a noncontact data transmission device 105 which mediates an optical or magnetic element. The preprocessing unit 106 executes preprocessing, e.g., correcting sensitivity nonuniformity between channels and correcting an extreme decrease in signal intensity or signal omission due to an X-ray absorber, mainly a metal portion, with respect to the data detected by the data acquisition device 104. The data (projection data) output from the preprocessor 106 which has undergone the preprocessing is supplied to a cone beam reconstruction processing unit 112 via a data storage unit 116.

The cone beam reconstruction processing unit 112 reconstructs volume data obtained by expressing CT value distributions in a three-dimensional coordinate system (xyz) by, for example, a cone beam reconstruction method based on the projection data in the angle range of 360° or (180°+fan angle) under the control of the host controller 110. The three-dimensional coordinate system (xyz) of volume data corresponds to a real space coordinate system (XYZ). The reconstructed volume data is stored in the data storage unit 116.

This embodiment generates a tomogram by using a multislice technique as described below and identifies a branch position by processing on the two-dimensional image in order to reduce the number of processing steps and the processing amount and maintain predetermined accuracy as compared with conventional three-dimensional processing of identifying a branch position after specifying the center line of a bronchus or blood vessel from volume data.

A tomogram generation unit 118 generates a plurality of slice images respectively corresponding to a plurality of slices almost perpendicular to the reference line set by a reference line setting unit 125 from volume data by so-called MPR processing (Multi Planar Reconstruction) suitable for display on a display unit (display) 113. A plurality of slices are arranged almost parallel at predetermined intervals (slice pitch) along the reference axis to form so-called multi slices. The data of a plurality of slice images are stored in the data storage unit 116. The operator can arbitrarily set a slice pitch and the spatial resolution of a tomogram as slice conversion conditions via the operation device 115.

The reference line setting unit 125 initially sets a reference line to the body axis of a subject. In general, the position of the subject on the top is adjusted to make the body axis of the subject almost coincide with the Z-axis. The reference line setting unit 125 corrects the position and direction of the reference line in accordance with the instruction input by the operator via the operation device 115. The reference line setting unit 125 also corrects the reference axis based on the position of the bronchus region extracted from a plurality of slice images by a bronchus region determination unit 119 in accordance with the first reference line automatic correction trigger input by the operator via the operation device 115. Typically, the reference line is corrected to a line connecting the barycentric positions of the bronchus regions extracted from at least two slice images, of a plurality of slice images, which cross the upper portion of the bronchus. The reference line setting unit 125 corrects the reference axis based on the center line of the upper portion of the bronchus from a three-dimensional region associated with the bronchus extracted by a binary processing unit 117 (to be described later) in accordance with the second reference line automatic correction trigger input by the operator via the operation device 115.

The binary processing unit 117 generates a plurality of binary images with respect to a plurality of slice images by threshold processing. This threshold is determined in accordance with a CT value unique to a region to be processed. If, for example, the region to be processed is the bronchus, a threshold is set to a value in the range of −800 to −1000 with air gas being an extraction target. This will extract a pixel group having a CT value less than the threshold as a bronchus region candidate. If a region to be processed is a contrasted blood vessel, a threshold is set to a value in the range of +800 to +1000 with a contrast medium being set as an extraction target. This will extract a pixel group having a CT value exceeding the threshold as a blood vessel region candidate. In the following description, assume that a region to be processed is the bronchus.

The operator can arbitrarily set a threshold and information indicating the difference between “less than”/“more than” the threshold as binary conditions for the extraction of such a region candidate via the operation device 115. Note that it is possible to extract pixels having CT values in the range determined by lower and upper thresholds when performing binary processing. In this case, the operator sets selection of an extraction method, a lower threshold, and an upper threshold as binary conditions.

The bronchus region determination unit 119 determines according to a predetermined determination rule whether each bronchus region candidate in each binary image is a bronchus region. The operator selects one of determination methods 1) to 4) to be described next or a combination of two or more of them via the operation device 115. 1) The bronchus region determination unit 119 performs this determination based on the area of a bronchus region candidate. An area is obtained by multiplying the number of pixels by a unit pixel area. Therefore, the number of pixels is essentially equivalent to an area. More specifically, the bronchus region determination unit 119 counts the number of pixels constituting each bronchus region candidate. If the counted number of pixels exceeds a threshold, e.g., 100 pixels, the bronchus region determination unit 119 determines that the bronchus region candidate is a bronchus region. 2) The bronchus region determination unit 119 performs the determination based on the perimeter of a bronchus region candidate. A perimeter is obtained by multiplying the number of peripheral pixels by a unit pixel length. Therefore, the number of peripheral pixels is essentially equivalent to a perimeter. More specifically, the bronchus region determination unit 119 counts the number of pixels constituting the outer edge of each bronchus region candidate. If the counted number of pixels exceeds a threshold, e.g., 50 pixels, the bronchus region determination unit 119 determines that the bronchus region candidate is a bronchus region. 3) The bronchus region determination unit 119 performs the determination based on the diameter of a bronchus region candidate. A “diameter” is defined as the length by which a straight which passes through the barycenter of a bronchus region candidate and is parallel to a predetermined direction crosses the bronchus region candidate. A diameter is obtained by multiplying the number of pixels on the crossing line by a unit pixel length. Therefore, the number of pixels is essentially equivalent to a diameter. More specifically, the bronchus region determination unit 119 counts the number of pixels. If the counted number of pixels exceeds a threshold, e.g., 20 pixels, the bronchus region determination unit 119 determines that the bronchus region candidate is a bronchus region. 4) The bronchus region determination unit 119 performs the determination based on the maximum or minimum diameter of a bronchus region candidate. A “maximum diameter (or minimum diameter)” is obtained from the maximum number of pixels (or the minimum number of pixels) obtained by measuring the length (the number of pixels) by which each of a plurality of straight lines passing through the barycenter of a bronchus region candidate crosses the bronchus region candidate. If the maximum number of pixels (or the minimum number of pixels) exceeds a threshold, e.g., 20 pixels, the bronchus region determination unit 119 determines that the bronchus region candidate is a bronchus region. Note that determination method 1) will be exemplified here.

A bronchus region counting unit 121 labels the respective binary images (the respective slices) of the determined bronchus regions with serial numbers 1, 2, . . . . The number of bronchus regions is determined for each binary image by labeling. Note that determination processing for a target site region is preferably performed such that, if the target site is the bronchus, a region candidate having a region size exceeding a threshold is determined as the region. If the target site is another site, a region candidate having a region size less than a threshold corresponding to the site may be determined as the site region. Alternatively, a region candidate having a region size in a predetermined range may be determined as the site region. The operator can arbitrarily set a threshold and information indicating the difference between “less than”/“more than” the threshold as determination conditions for such region determination via the operation device 115. The operator also sets information for selecting a determination method, a lower threshold, and an upper threshold.

A branch position determination unit 123 identifies the first branch position of the bronchus based on the slice position where the number of bronchus regions determined for each slice by the bronchus region counting unit 121 changes with respect to adjacent slices. That is, the branch position determination unit 123 specifies, as a branch position, a position on the reference axis at which the number of bronchus regions increases by only one. More specifically, the branch position determination unit 123 searches the subject from the head side to the lower extremity side for the number of bronchus regions, specifies a slice position where the number of regions changes from one to two, and identifies the Z position of the slice, the Z position of the immediately preceding slice, or the intermediate position between the specified slice and the immediately preceding slice as the first branch position (Z position) of the bronchus. The branch position determination unit 123 may search for the subject in the reverse direction. That is, the branch position determination unit 123 may search for the number of bronchus regions from the lower extremity side to the head side and specify a slice position where the number of regions changes from two to one. It is possible to arbitrarily set determination conditions in accordance with the determination target site and the state of a branch to be determined, and to arbitrarily set the numbers of regions before and after a change and a search direction via the operation device 115.

The operation device 115 automatically generates a tomogram including the identified branch position from volume data under the control of the host controller 110. The operator can arbitrarily set in advance generation conditions for a tomogram including the specified branch position, for example, a spatial resolution, information indicating execution/non-execution of interpolation processing, and oblique angles relative to the X-, Y-, and Z-axes via the operation device 115.

The display unit 113 displays the tomogram associated with the slice including the branch position with a mark indicating the branch position being superimposed on the tomogram. The display unit 113 also arranges and displays a plurality of slices within a predetermined distance from the branch position as the center, typically slice images of three slices, in the same frame. A mark indicating the branch position is superimposed on the tomogram including the branch position. The display unit 113 displays the three-dimensional image generated by performing rendering processing for the three-dimensional image associated with the bronchus from a volume data file by a three-dimensional processing unit 127. A mark indicating the branch position is superimposed on this three-dimensional image.

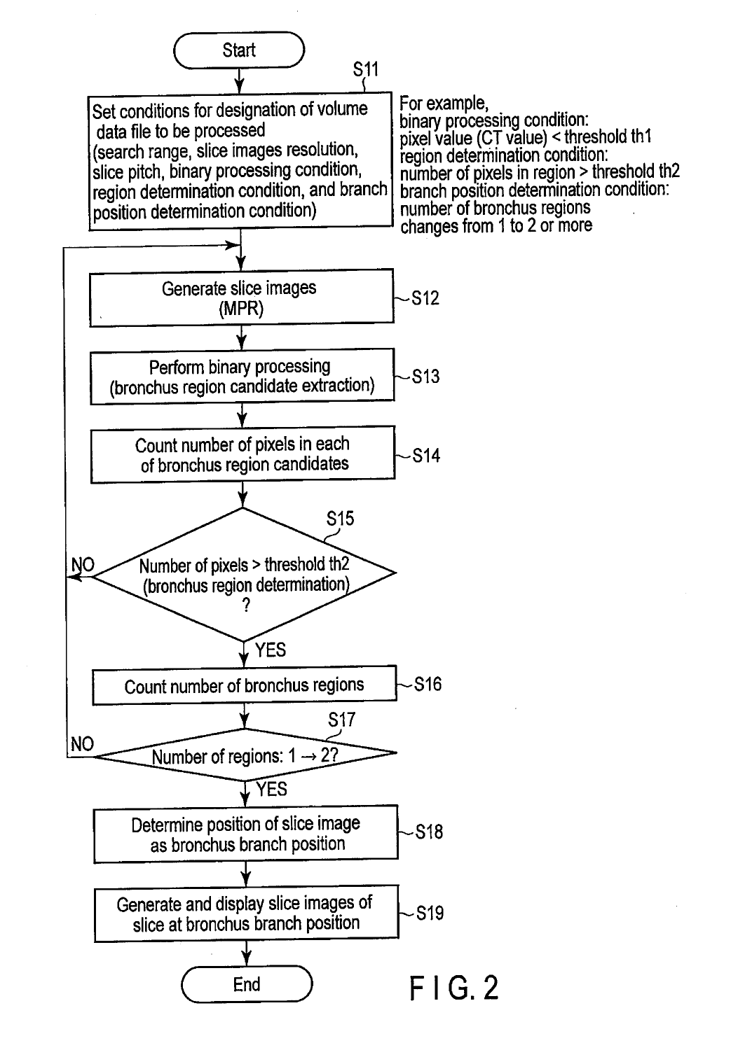

FIG. 2 shows a procedure for bronchus branch position specifying processing in this embodiment. The operator designates volume data to be processed and sets various processing conditions via the operation device 115 (S11). As described above, processing conditions include slice conversion conditions, binary conditions, region determination conditions, and branch position determination conditions. In the following description, assume that the operator sets information indicating that a processing target site is the bronchus, a slice pitch ΔSP as a slice conversion condition, information indicating that the spatial resolution of a tomogram is equivalent to the original spatial resolution of volume data, a condition of being less than a threshold th1 as a binary condition, a condition of being less than 100 pixels as a threshold th2 as a region determination condition, and a condition that the number of regions changes from one to two from the head side to the lower extremity side as a branch position determination condition.

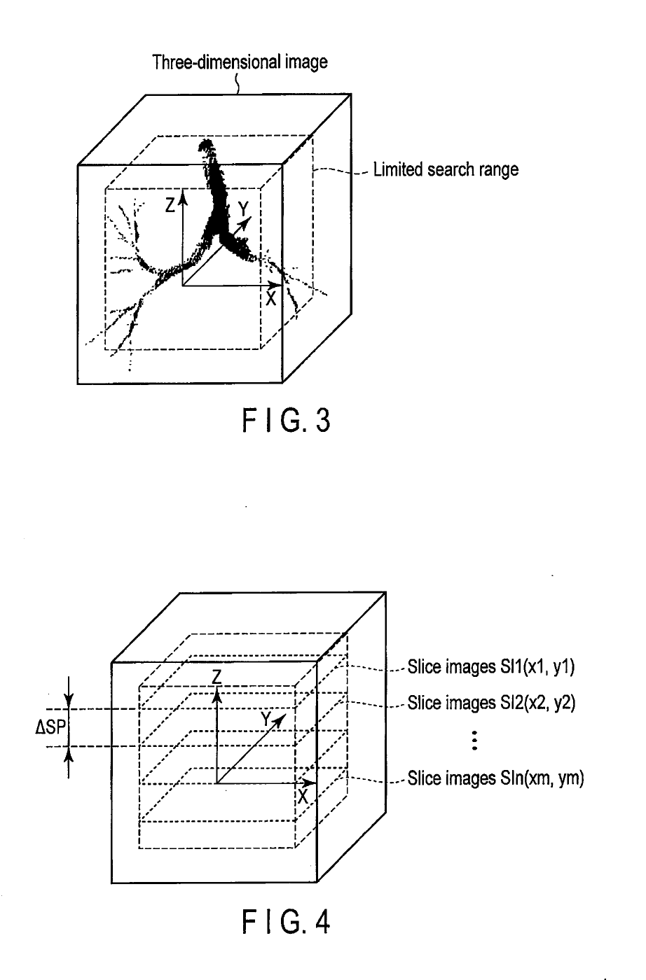

Note that before the start of processing, as shown in FIG. 3, the display unit 113 may display the three-dimensional image obtained by a volume rendering processing unit (not shown), and the operator may limit a search range including the main portion of the bronchus via the operation device 115. The apparatus executes processing from generation of a tomogram to a search for a branch position within this search range.

As shown in FIG. 4, the tomogram generation unit 118 generates a tomogram associated with a slice parallel to an X-Y plane almost perpendicular to the reference axis from volume data at intervals of the slice pitch ΔSP (S12). For the sake of descriptive convenience, a plurality of slices are written as S1, S2, S3, . . . sequentially from the head side. First of all, the tomogram generation unit generates a slice images 11 associated with the first slice S1 in the search order.

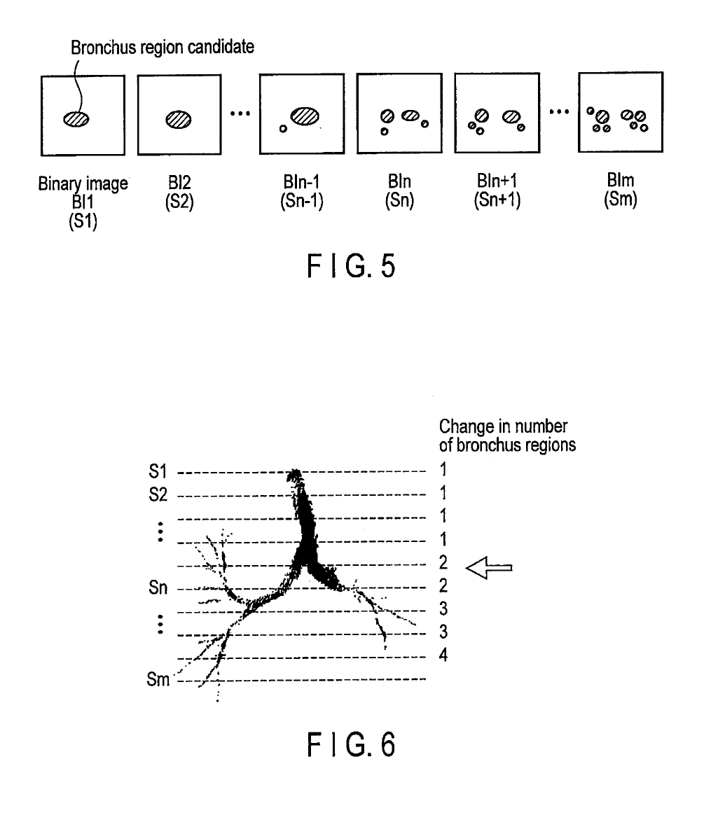

The binary processing unit 117 converts the slice images 11 into a binary image B11 with the threshold th1, as shown in FIG. 5 (S13). In the binary image B11, pixels having CT values lower than the threshold th1 are discriminated from pixels having CT values equal to or more than the threshold th1. As shown in FIG. 5, the bronchus region determination unit 119 extracts a plurality of regions, in each of which pixels having CT values smaller than threshold th1 are connected to each other, as a plurality of bronchus region candidates, and counts the number of pixels constituting each of the plurality of bronchus region candidates (S14). For all the plurality of bronchus region candidates, the bronchus region determination unit 119 compares the counted number of pixels with the threshold th2, e.g., 100 pixels (S15). If all the bronchus region candidates constituted by the numbers of pixels equal to or less than the threshold th2, the process returns to step S12 to execute the same processing as that in steps S12 to S15 for the next slice S2. The bronchus region determination unit 119 determines that a bronchus region candidate having a region size as the number of pixels larger than the threshold th2 is a bronchus region.

The bronchus region counting unit 121 counts the number of determined bronchus regions (S16). The branch position determination unit 123 specifies a slice where the number of bronchus regions changes in accordance with a branch position determination condition, and identifies a branch position (Z position) in accordance with the slice. As shown in FIGS. 5 and 6, on the slice S1 on the head side, the number of bronchus regions is “1”. The number of bronchus regions changes to “2” on the lower extremity side. A search is made for a branch position from the head side, and a branch position (Z position) is identified in accordance with a slice on which the number of branch regions changes from one to two. As shown in FIGS. 5 and 6, since the number of regions remains one until the slice Sn-1 immediately before the nth slice Sn on which the number of bronchus regions changes from “1” to “2”, the processing in steps S12 to S17 is repeated. On the slice Sn, the number of regions counts “2” for the first time. When the slice Sn is specified, on which the number of regions counts “2” for the first time, the processing in steps S12 to S17 is terminated.

The branch position determination unit 123 identifies the Z position of the slice Sn, on which the number of regions changes from one to two, as a branch position (S18). It is also possible to identify, as the branch position (Z position) of the bronchus, the Z position of the slice Sn-1 immediately before the slice Sn or the intermediate position between the specified slice Sn and the immediately preceding slice Sn-1. The operator can arbitrarily set either of these positions as a branch position. If the slice pitch ΔSP is relatively as short as a pitch of one voxel to a pitch of several voxels, it is preferable to identify the Z position of the slice Sn as a branch position. In contrast to this, if the slice pitch ΔSP is relatively as long as a pitch of several ten voxels, it is preferable to identify, as a branch position, the intermediate position between the specified slice Sn and the immediately preceding slice Sn-1.

In step S19, the tomogram generation unit 115 generates a tomogram including the identified branch position from volume data, and the display unit 113 displays the tomogram. As described above, this finally generated tomogram including the branch position is associated with a slice corresponding to an oblique angle relative to each of the X-, Y-, and Z-axes with the spatial resolution set in advance by the operator.

This embodiment extracts the first branch of the bronchus without extracting any center lines. Since it is possible to omit the processing of extracting center lines, the processing time can be shortened.

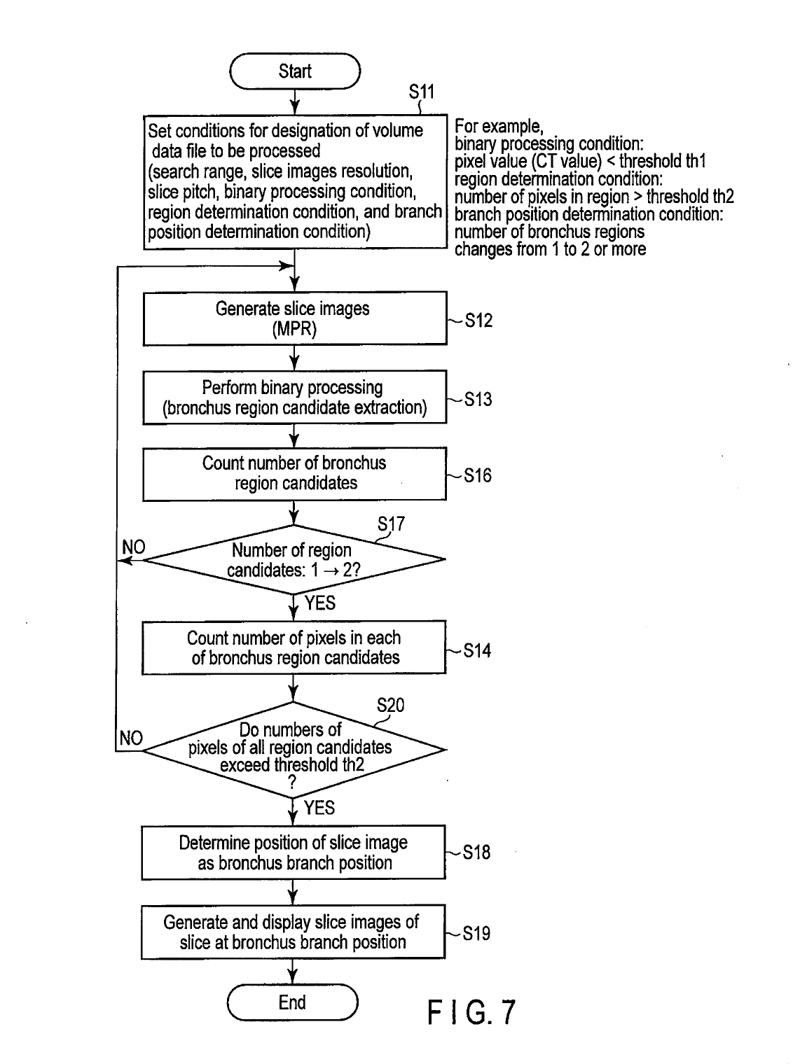

The processing procedure in FIG. 2 can be changed to that shown in FIG. 7. Referring to FIG. 2, the apparatus determines regions from region candidates based on the region sizes, and then determines a branch position based on a change in the number of regions. In contrast to this, in the case shown in FIG. 7, the apparatus determines a change in the number of region candidates (S17), and then determines whether the region sizes of all the region candidates satisfy a region determination condition (S20). If they satisfy the condition, the corresponding slice is identified as a branch position. The processing amount even in this procedure is larger than that in the processing procedure in FIG. 2, it is possible to determine a branch position with high accuracy as in the processing procedure in FIG. 2. In addition, the processing amount in this procedure is smaller than that of the processing including center line identity processing in the prior art.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical image processing apparatus comprising:
a storage unit configured to store volume data concerning a three-dimensional region of a subject;
a tomogram generation unit configured to generate data of a plurality of slice images respectively corresponding to a plurality of slices substantially perpendicular to a predetermined reference axis from the volume data files;
a region extraction unit configured to extract a plurality of regions associated with a target site from the plurality of slice images by using threshold processing; and
a position specifying unit configured to specify a position on the reference axis, wherein the number of extracted regions changes at the position.

2. The medical image processing apparatus of claim 1, wherein the reference axis is a body axis of the subject.

3. The medical image processing apparatus of claim 1, further comprising a reference axis setting unit configured to initially set the reference axis to the body axis of the subject and correct the reference axis based on positions of the extracted regions.

4. The medical image processing apparatus of claim 1, further comprising a reference axis setting unit configured to correct the reference axis in accordance with an instruction from an operator.

5. The medical image processing apparatus of claim 1, further comprising a reference axis setting unit configured to set the reference axis based on a three-dimensional region associated with the target site extracted from the volume data file by the threshold processing.

6. The medical image processing apparatus of claim 5, wherein the target site is a tubular site, and
the reference axis setting unit sets the reference axis based on an axis of the tubular site specified from the three-dimensional region.

7. The medical image processing apparatus of claim 1, further comprising a reference axis setting unit configured to correct the reference axis based on a barycenter of the region.

8. The medical image processing apparatus of claim 1, wherein the region extraction unit extracts, based on the numbers of pixels, a region of the target site from a plurality of region candidates extracted by the threshold processing.

9. The medical image processing apparatus of claim 1, wherein the region extraction unit extracts, based on perimeters of regions, a region of the target site from a plurality of region candidates extracted by the threshold processing.

10. The medical image processing apparatus of claim 1, wherein the region extraction unit extracts, based on diameters, a region of the target site from a plurality of region candidates extracted by the threshold processing.

11. The medical image processing apparatus of claim 1, wherein the region extraction unit extracts, based on a maximum diameter or a minimum diameter, a region of the target site from a plurality of region candidates extracted by the threshold processing.

12. The medical image processing apparatus of claim 1, wherein the target site is a bronchus or a blood vessel, and the position specifying unit specifies a branch position of the bronchus or blood vessel from the specified slice position.

13. The medical image processing apparatus of claim 12, wherein the position specifying unit specifies, as a position of a first branch of the bronchus, a position at which the number of regions changes from one to two or two to one.

14. The medical image processing apparatus of claim 1, wherein the position specifying unit specifies a position at which the number of regions increases or decreases by one.

15. The medical image processing apparatus of claim 1, further comprising a display unit configured to display one slice image selected from the plurality of generated slice images and including the specified position.

16. The medical image processing apparatus of claim 15, wherein the display unit superimposes a mark indicating the specified position on the displayed tomogram.

17. The medical image processing apparatus of claim 1, further comprising a display unit configured to display a plurality of slice images selected from the plurality of generated slice images and located within a predetermined distance centered on the specified position.

18. The medical image processing apparatus of claim 1, further comprising a three-dimensional image generation unit configured to generate a three-dimensional image associated with the target site from the volume data file; and
a display unit configured to display the three-dimensional image while superimposing a mark indicating the specified position on the image.

19. The medical image processing apparatus of claim 1, wherein the tomogram generation unit limits a range in which the tomogram is generated in accordance with an instruction from the operator.
